(19) United States
(12) Patent Application Publication
(10) Pub. No.: US 2012/0113103 A1
(43) Pub. Date: May 10, 2012

(54) APPARATUS AND METHOD FOR EXECUTING 3D APPLICATION PROGRAM USING REMOTE RENDERING

(75) Inventors: Kiheon KIM, Daejeon (KR); Wonhyuk CHOI, Daejeon (KR); Won-Young KIM, Daejeon (KR); Sung Jin HUR, Daejeon (KR)

(73) Assignee: Electronics and Telecommunications Research Institute, Daejeon (KR)

(21) Appl. No.: 13/288,210

(22) Filed: Nov. 3, 2011

(30) Foreign Application Priority Data
Nov. 4, 2010 (KR) 10-2010-0109103

(51) Int. Cl. G06T 15/00; G06F 15/16

(52) U.S. Cl. 345/419; 709/203

(57) ABSTRACT

An apparatus for executing a three-dimensional (3D) application program using remote rendering, the apparatus includes: a client apparatus for requesting execution of software and receiving rendering information generated from the execution of software to process the same; and a server apparatus for executing the software by the request from the client apparatus to transmit the rendering information generated from the executed software to the client apparatus.

### CROSS-REFERENCE(S) TO RELATED APPLICATION(S)

The present invention claims priority of Korean Patent Application No. 10-2010-0109103, filed on Nov. 4, 2010, which is incorporated herein by reference.

### FIELD OF THE INVENTION

The present invention relates to a technology for executing a three-dimensional (3D) application program of a server in a server-based computing environment; and, more particularly, to an apparatus and method for executing a 3D application program using remote rendering which are suitable for performing rendering by using a client's graphical processing unit (GPU) without using a server's GPU.

### BACKGROUND OF THE INVENTION

With the recent development of manufacturing technology of hardware such as central processing units (CPUs) and memories, cheap high performance computers are rapidly becoming widespread, and softwares for desktop computer are increasingly required to accommodate even fancier user interfaces and graphics-oriented operations. Moreover, the graphical processing unit (GPU) technology is extensively applied to web browser rendering, flash, and windows operating systems, as well as to the existing graphics-oriented operations such as 2D/3D and multimedia.

Meanwhile, the server-based computing environment is a solution for the problems such as data security and computer purchase/management costs, which occur in a personal computer-based computing environment. The technologies for supporting a server-based computing environment include Citrix XenDesktop, VMWare's VDI, terminal services based on Microsoft's remote desktop protocol (RDP), and the like.

Also, a server-based computing technique is used for data important for security reasons, such as medicine, bioinformatics, and 3D models of complex structures. However, in such server-based computing, the load of the server grows as the number of client increases, since the server executes software and the client computer only serves as a terminal. Moreover, there is a limitation in processing high-performance graphics operations such as 3D rendering since the server-based computing transmits result images executed in the server to the client. Accordingly, high-specification client computer resources may be wasted, and service limitations may be brought from server load. Also, this leads to the problems of huge cost for buying the server and slow service performance.

### SUMMARY OF THE INVENTION

In view of the above, the present invention provides an apparatus and method for executing a 3D application program using remote rendering, which can execute graphics-oriented operations such as 3D rendering by a client and process data-oriented operations by a server.

Further, the present invention provides an apparatus and method for executing a 3D application program using remote rendering, which can perform rendering using a client's graphical processing unit (GPU) without using a server's GPU when executing a server's 3D application program in a server-based computing environment.

In accordance with a first aspect of the present invention, there is provided an apparatus for executing a three-dimensional (3D) application program using remote rendering, the apparatus including:

a client apparatus for requesting execution of software and receiving rendering information generated from the execution of software to process the same; and

a server apparatus for executing the software by the request from the client apparatus to transmit the rendering information generated from the executed software to the client apparatus.

In accordance with a second aspect of the present invention, there is provided an apparatus for executing a three-dimensional (3D) application program using remote rendering, the apparatus including:

a software execution unit for generating a message requesting execution of an application program to transmit the generated message to a server apparatus;

a data transmission/reception unit for receiving rendering information from the server apparatus;

a processing unit for decoding and decompressing the received rendering information, and performing a rendering operation based on the decoded and decompressed rendering information; and

a display unit for displaying a result of the performance of the rendering operation on a screen.

In accordance with a third aspect of the present invention, there is provided an apparatus for executing a three-dimensional (3D) application program using remote rendering, the apparatus including:

a software management unit for executing an application program, when a message requesting execution of the application program is received from a client apparatus among multiple client apparatuses connected thereto;

an information extraction unit for continuously extracting rendering information generated from the executed application program;

a compressing and encoding unit for compressing and encoding the extracted rendering information; and

a data transmission/reception unit for transmitting the compressed and encoded rendering information to the client apparatus.

In accordance with a fourth aspect of the present invention, there is provided a method for executing a three-dimensional (3D) application program using remote rendering, the method including:

requesting execution of software from a client apparatus to a server apparatus;

executing, in the server, the software requested by the client apparatus;

transmitting rendering information of the executed software from the server apparatus to the client apparatus;

receiving, at the client apparatus, the rendering information of the executed software from the server apparatus; and

performing, at the client apparatus, a rendering operation based on the received rendering information.

In accordance with a fifth aspect of the present invention, there is provided a method for executing a three-dimensional (3D) application program using remote rendering, the method including:

generating a message requesting execution of an application program;

transmitting the generated message to a server apparatus to receive rendering information from the server apparatus;

decoding and decompressing the received rendering information;

performing a rendering operation based on the decoded and decompressed rendering information;

compressing and encoding rendering data generated from the rendering operation; and

transmitting the compressed and encoded rendering result data to the server apparatus.

In accordance with a sixth aspect of the present invention, there is provided a method for executing a three-dimensional (3D) application program using remote rendering, the method including:

executing an application program, when a message requesting execution of the application program is received from a client apparatus;

continuously extracting rendering information generated from the executed application program;

compressing and encoding the extracted rendering information; and

transmitting the compressed and encoded rendering information to the client apparatus.

### BRIEF DESCRIPTION OF THE DRAWINGS

The objects and features of the present invention will become apparent from the following description of embodiments, given in conjunction with the accompanying drawings, in which:

FIG. 1 is a block diagram illustrating a structure of an apparatus for executing a 3D application program using remote rendering in accordance with an embodiment of the present invention;

FIG. 2 is a block diagram illustrating a structure of a rendering information execution unit in a client apparatus in accordance with the embodiment of the present invention.

FIG. 3 is a flowchart illustrating an operation procedure of a server apparatus in accordance with the embodiment of the present invention; and

FIG. 4 is a flowchart illustrating an operation procedure of the client apparatus in accordance with the embodiment of the present invention.

### DETAILED DESCRIPTION OF THE EMBODIMENT

An embodiment of the present invention enables a client apparatus to process operation data of software executed by a server in a server-based computing environment. When a server executes a 3D application program, graphics-oriented operations such as 3D rendering are rendered using a client's graphics processing unit (GPU), and data-oriented operations are processed by the server.

The rendering information includes at least one of the following: geometry, point of view, texture mapping, lighting, and shading information. The client apparatus performs a rendering operation for generating an image based on this information.

Hereinafter, embodiments of the present invention will be described with reference to the accompanying drawings which form a part hereof.

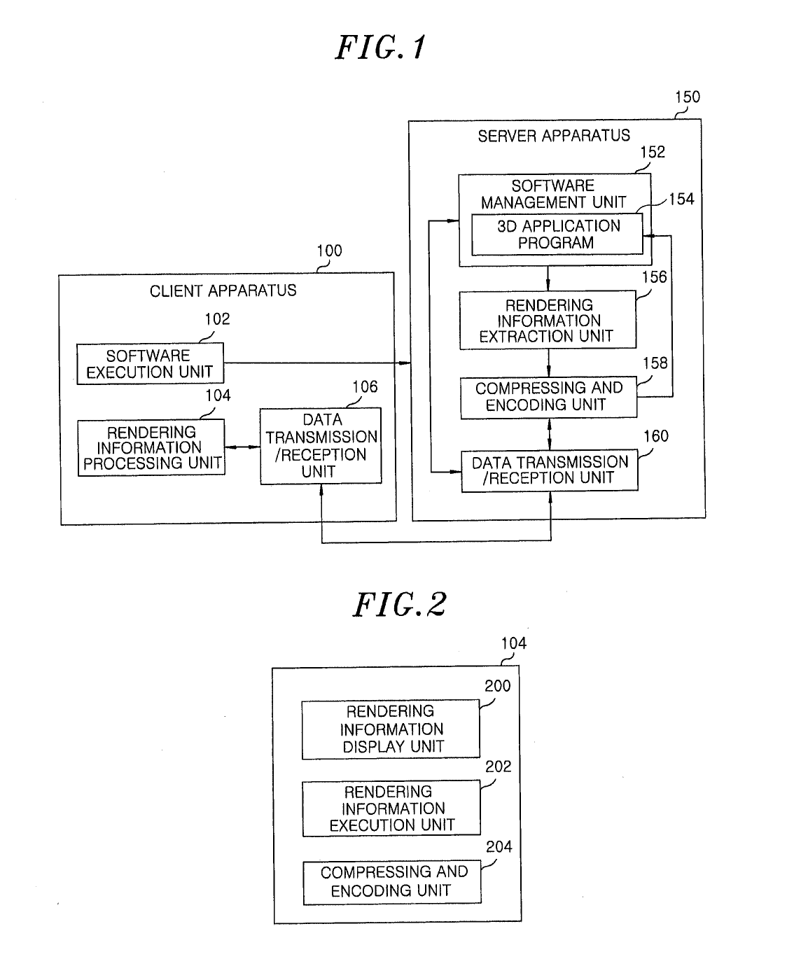

FIG. 1 is a block diagram illustrating a structure of an apparatus for executing a 3D application program using remote rendering in accordance with an embodiment of the present invention.

Referring to FIG. 1, the apparatus includes a client apparatus 100 and a server apparatus 150.

The client apparatus 100 includes a software execution unit 102, a rendering information processing unit 104, a data transmission/reception unit 106. The server apparatus 150 includes a software management unit 152, a rendering information extraction unit 156, a compressing and encoding unit 158 and a data transmission/reception unit 160.

The software execution unit 102 of the client apparatus 100 generates a message requesting execution of software, in particular, of a 3D application program, and transmits it to the software management unit 152 of the server apparatus 150 via a control message transmission unit (not shown) included in the client apparatus 100.

The data transmission/reception unit 106 delivers, upon receipt of rendering information from the server apparatus 150, the rendering information to the rendering information processing unit 104.

The rendering information processing unit 104 receives the rendering information, which is software operation data transmitted from the server apparatus 150, through the data transmission/reception unit 106, and performs rendering operation based on the received rendering information.

Specifically, as shown in FIG. 2, the rendering information processing unit 104 includes a rendering information display unit 200, a rendering information execution unit 202 and a compressing and encoding unit 204.

The rendering information execution unit 202 performs rendering operation based on the rendering information. The rendering information display unit 200 displays on a screen a result of the rendering operation carried out by the rendering information execution unit 202. The compressing and encoding unit 204 compresses and encodes rendering result data generated as a result of the rendering operation to deliver it to the server apparatus 150 via the data transmission/reception unit 106.

Meanwhile, since the rendering information is compressed and encoded in the server apparatus 150 before being transmitted to the client apparatus 100, there is a need for the client apparatus 100 to decode and decompress the rendering information, which is also performed by the compressing and encoding unit 204. That is to say, the compressing and encoding unit 204 receives the rendering information from the data transmission/reception unit 106 and decodes and decompresses it so that the rendering information execution unit 202 can perform the rendering operation based on the decoded and decompressed rendering information.

Meanwhile, the software management unit 152 of the server apparatus 150 shown in FIG. 1 manages execution and termination of software by request from the client apparatus 100. Upon receipt of the message requesting execution of the 3D application program, which is transmitted from the software execution unit 102 of the client apparatus 100, the software management unit 152 performs the execution of the 3D application program 154.

While the 3D application program 154 is executed by the server apparatus 150, user interface and 3D rendering are processed by the rendering information processing unit 104 of the client apparatus 100. At this point, the GPU of the server apparatus 150 is not used, but the GPU of the client apparatus 100 is used.

The rendering information extraction unit 156 continuously extracts rendering information being generated while the 3D application program 154 is executed by the software management unit 152. The extracted rendering information is delivered to the compressing and encoding unit 158.

The compressing and encoding unit 158 performs compressing and encoding before transmitting the rendering information to the client apparatus 100. Hence, even when the file is intercepted by someone during its transmission to the client apparatus 100, the file cannot be opened unless the unique operation for the compressing and encoding of the server apparatus 150 is known.

The compressed and encoded rendering information is transmitted to the client apparatus 100 through the data transmission/reception unit 160.

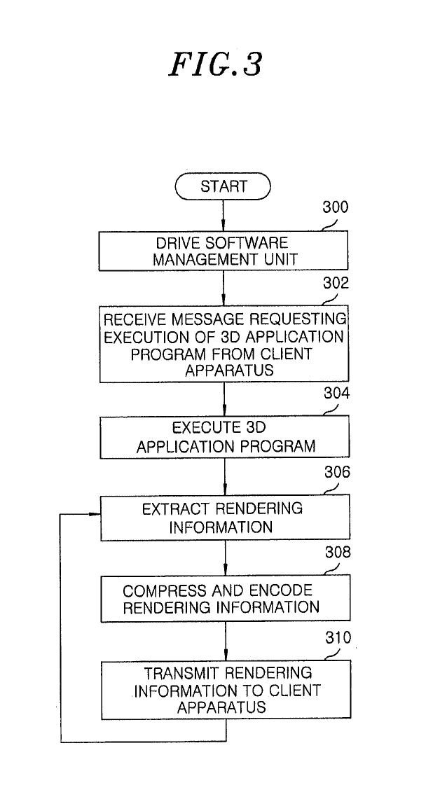

FIG. 3 is a flowchart illustrating an operation procedure of a server apparatus in accordance with the embodiment of the present invention.

Referring to FIG. 3, the server apparatus 150 drives the software management unit 152 in step 300, and receives a message requesting execution of a 3D application program from the client apparatus 100 in step 302. In response to the request, the software management unit 152 executes the corresponding 3D application program 154 in step 304.

While the 3D application program 154 is executed, rendering information is continuously generated. The rendering information extraction unit 156 intercepts and extracts the rendering information generated by the 3D application program 154 in step 306 before the rendering information is processed by the GPU.

The extracted rendering information is compressed and encoded by the compressing and encoding unit 158 in step 308. The rendering information that has been compressed and encoded is delivered to the client apparatus 100 via the data transmission/reception unit 160 in step 310.

The server apparatus 150 repetitively performs the procedure of extracting rendering information, compressing and encoding the rendering information, and transmitting it to the client apparatus 100 until one 3D application program 154 is terminated after its execution. Such an operation of the server apparatus 150 is stopped only when a message requesting execution stoppage of the 3D application program 154 is received from the software execution unit 102 of the client apparatus 100.

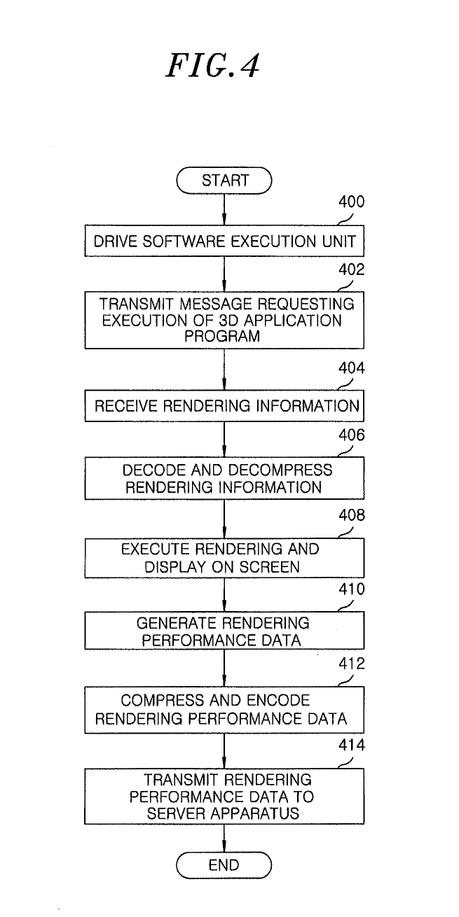

FIG. 4 is a flowchart illustrating an operation procedure of the client apparatus in accordance with the embodiment of the present invention.

Referring to FIG. 4, in step 400, the client apparatus 100 drives the software execution unit 102, and accesses the software management unit 152 of the server apparatus 150 to check a list of 3D application programs which are available.

When a user selects a specific 3D application program from the list, the software execution unit 102 transmits a message requesting execution of the selected 3D application program 154 to the server apparatus 150 in step 402.

Thereafter, in step 404, the rendering information processing unit 104 receives rendering information from the server apparatus 150 via the data transmission/reception unit 106. The compressing and encoding unit 204 of the rendering information processing unit 104 decodes and decompresses the rendering information in step 406.

Next, in step 408, the rending information execution unit 202 of the rendering information processing unit 104 executes 3D rendering by using the GPU of the client apparatus 100 based on the decoded and decompressed rendering information, and the rendering information display unit 200 displays a result of the rendering execution on the screen. The rending information execution unit 202 generates rendering result data as a result of the rendering execution in step 410.

In step 412, the compressing and encoding unit 204 compresses and encodes the rendering result data generated by the rendering information execution unit 202. The compressed and encoded rendering result data is transmitted to the server apparatus 150 via the data transmission/reception unit 106 in step 414.

Then, the compressing and encoding unit 158 of the server apparatus 150 decodes and decompresses the rendering result data transmitted from the client apparatus 100. The decoded and decompressed rendering result data is delivered to the software management unit 152, and the software management unit 152 stores the rendering result data in a storage area of the 3D application program 154.

As described above, the apparatus and method for executing a 3D application program using remote rendering in accordance with the embodiment of the present invention executes graphics-oriented operations such as 3D rendering using a client's GPU and processes data-oriented operations by a server when executing a server's 3D application program in a server-based computing environment.

In accordance with the present invention, a 3D application program is executed by a server using data stored in the server, but rendering is performed by the client and therefore has the following advantages over server-based computing.

First, since applications that frequently use a GPU such as 3D rendering employ a client's GPU, a large number of clients can be processed with higher performance than the server-based computing using a GPU in a shared manner.

Second, unlike a method of transmitting and displaying a result image of execution of software each time the screen is updated, rendering information of a smaller volume than the image is transmitted to and executed by the client. Thus, graphics can be displayed by making the best use of the performance of the client's GPU, with improved performance compared to the conventional method.

Third, server-based computing displays the entire screen of the operating system (OS) of the server to the client, whereas the present invention can display only the screen of a corresponding 3D application program.

While the invention has been shown and described with respect to the embodiments, it will be understood by those skilled in the art that various changes and modification may be made without departing from the scope of the invention as defined in the following claims.

What is claimed is:

1. An apparatus for executing a three-dimensional (3D) application program using remote rendering, the apparatus comprising:
a client apparatus for requesting execution of software and receiving rendering information generated from the execution of software to process the same; and
a server apparatus for executing the software by the request from the client apparatus to transmit the rendering information generated from the executed software to the client apparatus.

2. The apparatus of claim 1, wherein the client apparatus includes:
a software execution unit for transmitting a message requesting execution of a 3D application program to the server apparatus;
a data transmission/reception unit for receiving rendering information transmitted from the server apparatus; and
a rendering information processing unit for performing a rendering operation based on the rendering information.

3. The apparatus of claim 2, wherein the rendering information processing unit includes:
a compressing and encoding unit for decoding and decompressing the rendering information;
a rendering information execution unit for performing rendering operation based on the decoded and decompressed rendering information; and
a rendering information display unit for displaying a result of the performance of the rendering operation.

4. The apparatus of claim 3, wherein the compressing and encoding unit compresses and encodes rendering result data generated from the rendering operation performed by the rendering information execution unit.

5. The apparatus of claim 1, wherein the server apparatus includes:
a software management unit for executing a 3D application program, when a message requesting execution of the 3D application program is received from the client apparatus;
a rendering information extraction unit for extracting rendering information generated from the executed 3D application program;
a compressing and encoding unit for compressing and encoding the extracted rendering information; and
a data transmission/reception unit for transmitting the compressed and encoded rendering information to the client apparatus.

6. The apparatus of claim 5, wherein the compressing and encoding unit, when rendering result data is received from the client apparatus, decodes and decompresses the rendering result data, and the software management unit stores the decoded and decompressed rendering result data in a storage area of the 3D application program.

7. An apparatus for executing a three-dimensional (3D) application program using remote rendering, the apparatus comprising:
a software execution unit for generating a message requesting execution of an application program to transmit the generated message to a server apparatus;
a data transmission/reception unit for receiving rendering information from the server apparatus;
a processing unit for decoding and decompressing the received rendering information, and performing a rendering operation based on the decoded and decompressed rendering information; and
a display unit for displaying a result of the performance of the rendering operation on a screen.

8. The apparatus of claim 7, wherein the apparatus compresses and encodes rendering result data generated from the rendering operation performed by the processing unit, and transmits the compressed and encoded rendering result data from the data transmission/reception unit to the server apparatus.

9. An apparatus for executing a three-dimensional (3D) application program using remote rendering, the apparatus comprising:
a software management unit for executing an application program, when a message requesting execution of the application program is received from a client apparatus among multiple client apparatuses connected thereto;
an information extraction unit for continuously extracting rendering information generated from the executed application program;
a compressing and encoding unit for compressing and encoding the extracted rendering information; and
a data transmission/reception unit for transmitting the compressed and encoded rendering information to the client apparatus.

10. The apparatus of claim 9, wherein the compressing and encoding unit, when rendering result data is received from the client apparatus, decodes and decompresses the rendering result data, and the software management unit stores the decoded and decompressed rendering result data in a storage area of the application program.

11. A method for executing a three-dimensional (3D) application program using remote rendering, the method comprising:
requesting execution of software from a client apparatus to a server apparatus;
executing, in the server, the software requested by the client apparatus;
transmitting rendering information of the executed software from the server apparatus to the client apparatus;
receiving, at the client apparatus, the rendering information of the executed software from the server apparatus; and
performing, at the client apparatus, a rendering operation based on the received rendering information.

12. The method of claim 11, wherein, in said requesting the execution of software, a message requesting execution of a 3D application program is transmitted from the client apparatus to the server apparatus.

13. The method of claim 11, wherein said performing the rendering operation includes:
decoding and decompressing the received rendering information; and
performing the rendering operation based on the decoded and decompressed rendering information.

14. The method of claim 11, further comprising:
compressing and encoding, at the client apparatus, rendering result data generated by performing the rendering operation.

15. The method of claim 11, wherein said executing the software includes:
executing, when a message requesting execution of a 3D application program is received from the client apparatus, the 3D application program;
extracting rendering information generated from the executed 3D application program; and
compressing and encoding the extracted rendering information.

16. The method of claim 14, further comprising:
receiving, at the server apparatus, the compressed and encoded rendering result data from the client apparatus;
decoding and decompressing the rendering result data; and
storing the decoded and decompressed rendering result data in a storage area of the software.

17. The method of claim 11, wherein the rendering information includes at least one of geometry, point of view, texture mapping, lighting and shading information.

18. A method for executing a three-dimensional (3D) application program using remote rendering, the method comprising:
generating a message requesting execution of an application program;
transmitting the generated message to a server apparatus to receive rendering information from the server apparatus;
decoding and decompressing the received rendering information;
performing a rendering operation based on the decoded and decompressed rendering information;
compressing and encoding rendering result data generated from the rendering operation; and
transmitting the compressed and encoded rendering result data to the server apparatus.

19. A method for executing a three-dimensional (3D) application program using remote rendering, the method comprising:
executing an application program, when a message requesting execution of the application program is received from a client apparatus;
continuously extracting rendering information generated from the executed application program;
compressing and encoding the extracted rendering information; and
transmitting the compressed and encoded rendering information to the client apparatus.

20. The method of claim 19, further comprising:
decoding and decompressing, upon receipt of rendering result data from the client apparatus, the rendering result data; and
storing the decoded and decompressed rendering result data in a storage area of the application program.
